(19) United States
(12) Patent Application Publication
(10) Pub. No.: US 2007/0041783 A1
(43) Pub. Date: Feb. 22, 2007

(54) Solid post scrapbook adapter

(76) Inventor: Curt D. Seymour, Parkville, MO (US)

Correspondence Address: SONNENSCHEIN NATH & ROSENTHAL LLP, P.O. BOX 061080, WACKER DRIVE STATION, SEARS TOWER, CHICAGO, IL, 60606-1080, US

(21) Appl. No.: 11/339,963

(22) Filed: Jan. 25, 2006

Related U.S. Application Data
(60) Provisional application No. 60/647,041, filed on Jan. 25, 2005.

(51) Int. Cl. B42F 13/12

(52) U.S. Cl. 402/70

(57) ABSTRACT

A post adapter for scrapbooks, albums, and binders and the like is provided. The adapter includes a pair of mating plates connected together by two or more posts.

This application claims priority pursuant to 35 U.S.C. 119(e) to co-pending U.S. Provisional Patent Application Ser. No. 60/647,041, filed Jan. 25, 2005, the entire disclosure of which is incorporated herein by reference.

### FIELD OF THE INVENTION

The present invention relates generally to post-bound scrapbooks, albums, binders and the like. More specifically, the present invention is concerned with a solid post adapter for scrapbooks, albums and the like.

### BACKGROUND OF THE INVENTION

Post-bound scrapbooks, albums, etc. come in a variety of different designs, such as two-post, three-post, etc. The posts generally extend through the front and back covers to connect the covers and pages located within the scrapbook (or other album/book) together as a single unit. A common problem with post-bound scrapbooks is due to the fact that the cover materials are relatively soft compared to the posts. The covers are generally made of a cardboard core with a fabric or paper exterior, while the posts are generally metal. All of the stresses of holding together the front and back covers are isolated at the locations in which each of the posts is extended through the covers. This often results in the post tearing through the softer cover material. To help distribute the stress across a larger areas of the covers, manufacturers have included metal washers around the posts. This results in a less desirable appearance for the scrapbook, and still can result in a washer and post together tearing through the cover material. Therefore, it would be beneficial to provide a post-style binder for scrapbooks, albums and the like that is aesthetically pleasing and which alleviates the problem of post tear-through of the covers.

### SUMMARY OF THE INVENTION

An object of the instant invention is to provide a post-style binder for scrapbooks, albums, and the like. Another object of the instant invention is to provide a post-style binder that is aesthetically pleasing. Still another object of the instant invention is to provide a post-style binder that alleviates the problem of post tear-through.

The objects of the instant invention are accomplished through the use of a pair of mating plates connected together by two or more posts. The plates are located at both the front and back cover of the scrapbook, album, book, etc., (referred to generally herein as scrapbook(s)) and are constructed of a generally rigid material (stronger than the material from which the cover is made), such as metal, hard plastic, plexi-glass, etc. The posts extend through the covers in the manner discussed with respect to the prior art and connect to each of the plates. All of the posts (whether two, three, or more) are connected together by the mating plates, such that the stresses of holding the covers (and contained pages) are distributed across the entire length of the plate and thus distributed across the entire length of the section of cover to which the plate contacts, eliminating post tear-through.

The adapter of the instant invention can be retro-fitted into existing scrapbooks, or alternatively can be incorporated into new scrapbooks. For retrofit applications, the mating plates will be loose pieces that are held to the covers only by the compressive forces of the post-connection. For new applications, the mating plates may be permanently affixed to the covers, such as by gluing, embedding within paper of fabric of the covers, or by some other connection now known or hereafter developed. The mating plates of the instant can be located on the inside of the scrapbook (album, etc.) by using an inwardly folded spine-edge arrangement that is well known in the art. Alternatively, the plates may be located on the outside of the scrapbook (album, etc.).

In one embodiment of the instant invention, the posts are welded to one of the two mating plates, and include female threads at the opposing end from the weld. The opposing mating plate includes holes through which screws extend to thread into the female threads of the posts. The holes include a counter sink section so that the screw will lie flush with the surface of the plate. The instant invention also accommodates the use of a post extension that may be threaded into the posts that are welded to the mating plate. The opposing mating plate is then connected to the extension by threading screws into female threads in the opposing end of the post. This allows the thickness of the binding to be easily extended to accommodate additional pages in the scrapbook, album, etc. Although discussed herein with respect to the welded posts, it will be appreciated that the post extensions may be utilized in connection with any of the alternative embodiments discussed below or hereinafter developed.

In alternative embodiments both ends of the posts are threadingly connected to both of the mating plates. In one embodiment, one end of each post includes male threads that engage female threads located in one of the mating plates. The other end of the post includes female threads and are connected by a screw connection in the same manner discussed above with respect to the welded-post embodiment. In another embodiment, both ends of the posts are connected to the mating plates by screws that thread with female threads in both ends of the post. In one embodiment of the invention one end of the post includes a notched section that engages with a matching notch in the mating plate to prevent rotation of the post during tightening.

In a preferred embodiments of the instant invention discussed above in which the posts are threadingly connected to the mating plates, the mating plates include tapered holes in which the ends of the post fit. This prevents pages within the book from becoming caught between the end of the post and the mating plate.

The foregoing and other objects are intended to be illustrative of the invention and are not meant in a limiting sense. Many possible embodiments of the invention may be made and will be readily evident upon a study of the following specification and accompanying drawings comprising a part thereof. Various features and subcombinations of invention may be employed without reference to other features and subcombinations. Other objects and advantages of this invention will become apparent from the following description taken in connection with the accompanying drawings, wherein is set forth by way of illustration and example, an embodiment of this invention and various features thereof.

### BRIEF DESCRIPTION OF THE DRAWINGS

Preferred embodiments of the invention, illustrative of the best mode in which the applicant has contemplated applying the principles, are set forth in the following description and are shown in the drawings and are particularly and distinctly pointed out and set forth in the appended claims.

FIG. 1a is side section view of a scrapbook including a post adapter of the instant invention.

FIG. 1b is a top perspective view of the front cover of the scrapbook of FIG. 1a.

FIG. 2 is a perspective view of a welded-post embodiment of the scrapbook adapter of the instant invention.

FIG. 3 is a perspective view of double-threaded post embodiment of the scrapbook adapter of the instant invention.

FIGS. 4a and 4b show a notched post embodiment of the instant invention and corresponding notch located in the mating plate with FIG. 4a showing a side elevation view of the notched post and FIG. 4b showing a plan view of the front mating plate with corresponding notch.

FIG. 5 shows a side elevation view of an embodiment of a post adapter of the instant invention in which both ends of the posts are connected via screws to the mating plates.

FIGS. 6a and 6b show a top (or outer surface) plan and a side elevation views, respectively, of a front (or back) mating plate of the instant invention including a hole with a counter sink section.

FIGS. 7a and 7b show a bottom plan and side elevation views, respectively, of a post or an extension post for use in connection with the instant invention.

### DETAILED DESCRIPTION OF PREFERRED EMBODIMENTS

As required, detailed embodiments of the present invention are disclosed herein; however, it is to be understood that the disclosed embodiments are merely exemplary of the principles of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually and appropriately detailed structure.

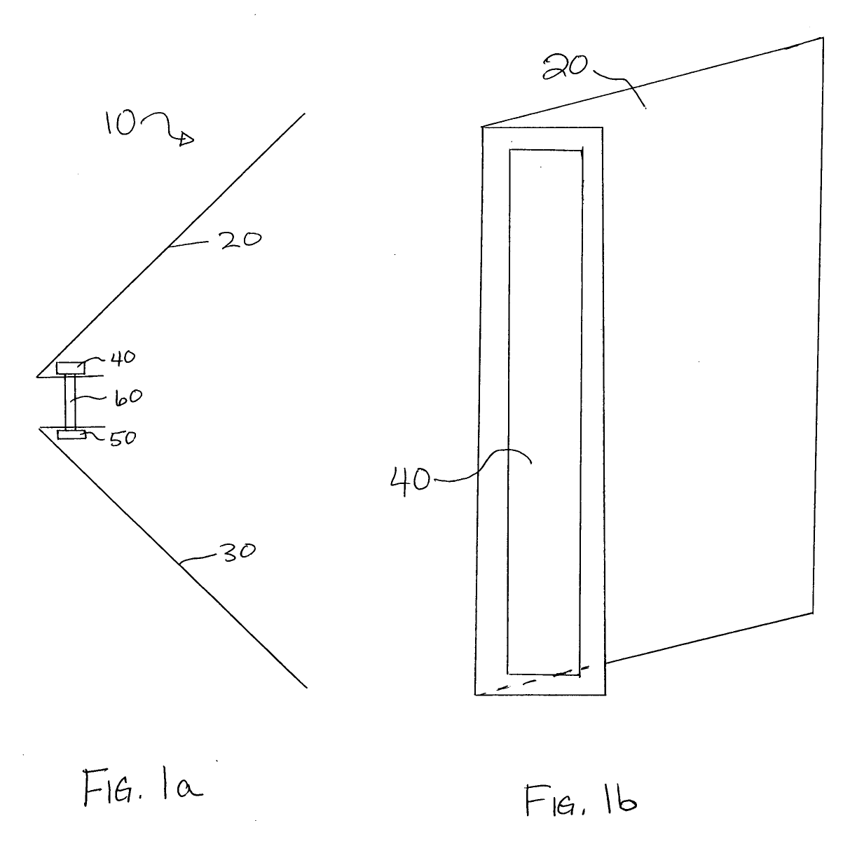

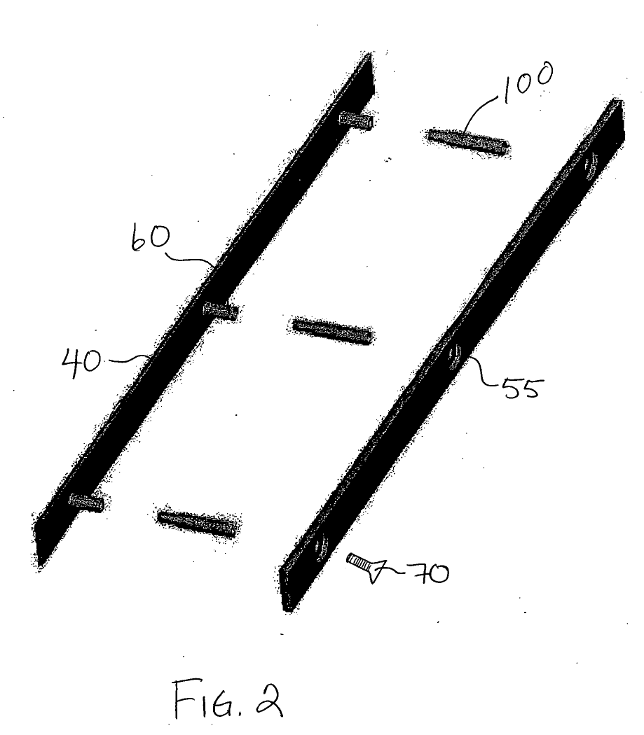

Referring to FIG. 1a and FIG. 1b a scrapbook, 10, exemplifying an embodiment of the present invention is shown. Scrapbook 10 has front cover 20 and back cover 30, both constructed of cardboard, paper, fabric, etc., or combinations thereof. Front plate 40 is located on the inside of front cover 20 in the manner shown in FIGS. 1a and 1b. In addition, an additional length of material (not shown) approximately the width of the spine folded over front plate 40 in the manner well known in the art to conceal front plate 40. Back plate 50 is located on the inside of back cover 30 in the manner shown in FIGS. 1a and 1b. It will be appreciated that other spine configurations can be utilized, such as those in which the post hardware is located on or extends through to the outside of the front and back covers, without departing from spirit and scope of invention. Front plate 40 is connected to back plate 50 by two or more generally cylindrical posts 60. Front plate 40, back plate 50 and posts 60 are constructed of a generally rigid material, such as metal, hard plastic, plexi-glass or any other suitable material now known or hereafter discovered that is stronger than the material (typically cardboard, paper, fabric, etc.) of front cover 20 and back cover 30. Front plate 40 and back plate 50 can be manufactured separately from scrapbook 10 and installed by the end consumer. Alternatively, front plate 40 and back plate 50 may be inserted within front cover 20 and back cover 30 during manufacturing so that the end consumer is not required to assemble, thereby reducing assembly time of the overall scrapbook 10. In such an embodiment, either the front plate or the back plate, or both may be permanently affixed or integrated into the respective covers, if desired, during manufacture.

Referring to FIG. 2, posts 60 are welded to either mating plate 40 or 50. For purposes of example only, the instant invention is described herein with posts 60 welded to front plate 40; however it will be appreciated that the posts can be welded to either mating plate 40 or 50. Additionally, the front plate 40 and back plate 50 configurations described herein may be reversed and/or are interchangeable for all embodiments. Posts 60 include female threads at the opposing end from the weld. Back plate 50 includes holes 55 through which screws 70 extend to thread into the female threads of posts 60. Holes 55 include a counter sink section so that screw 70 will lie flush with the surface of back plate 50. The instant invention also accommodates the use of post extension 100 that optionally may be threaded into posts 60 that are welded to front plate 40. The top of extension post 100 includes male threads that connect to the female threads in the end of post 60. Back plate 80 is then connected to post extension 100 by threading screws 70 into female threads in the opposing end of extension post 100. This allows the thickness of the binding to be easily extended to accommodate additional pages in scrapbook 10 if so desired.

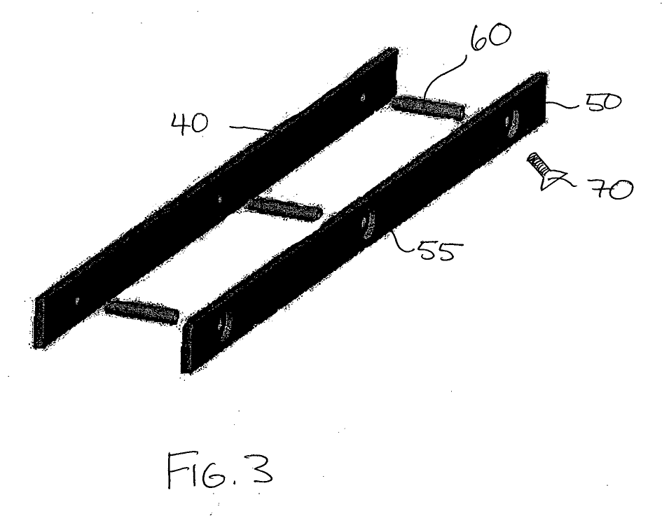

In alternative embodiments both ends of posts 60 are threadingly connected to the mating plates. In such embodiments, extension post 100, or other similar post constructions, may be used for posts 60 to connect front and back plates together. Furthermore, it will be appreciated that multiple posts may be connected together and/or posts/extension posts of various sizes may be utilized in connection with the instant invention. Referring to FIG. 3, one end of each post 60 includes male threads that engage female threads located in front plate 40. The other end of post 60 includes female threads that are connected by screws 70 which extend through the back plate 50 to thread into the female threads of the post 60. Back plate 50 includes holes 55 that include a counter sink section so that screw 70 will lie flush with the surface of back plate 50. In a similar embodiment, referring to FIG. 5, both ends of post 60 are connected to the mating plates 40 and 50 by screws 70 that thread with female threads in both ends of post 60.

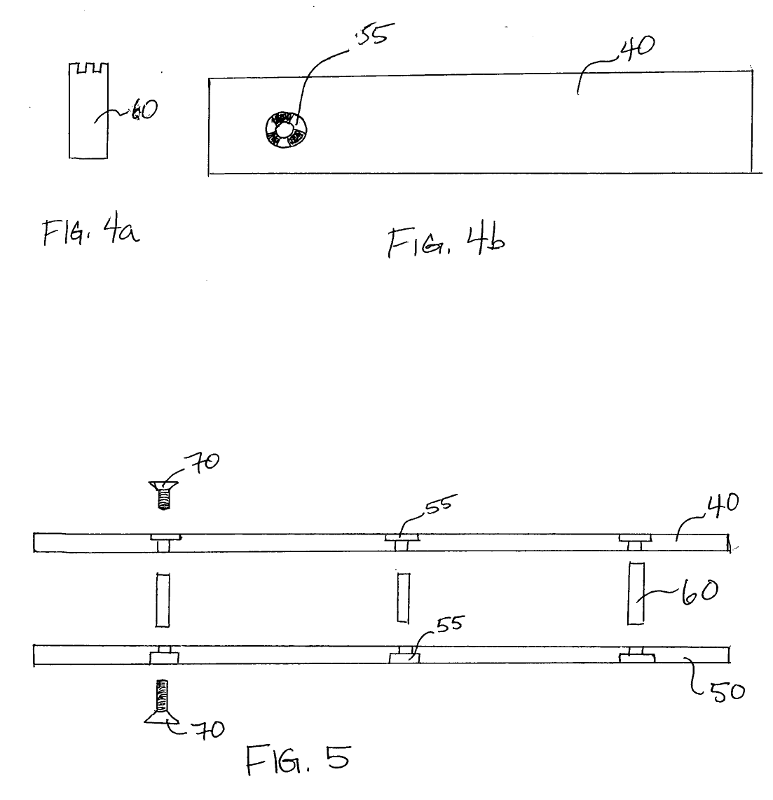

Referring to FIG. 4a and FIG. 4b, an alternative embodiment is shown in which a notch is located in one end of post 60. As is shown, holes 55 of front plate 40 include an opposing notch to that of post 60 such that the notched portion of post 60 engages the notch of holes 55 to prevent rotation of post 60 during tightening of screws 70. Such an embodiment is particularly useful for the embodiment of the invention discussed above with respect to FIG. 4, in which post 60 is connected to both of plates 40 and 50 by screws.

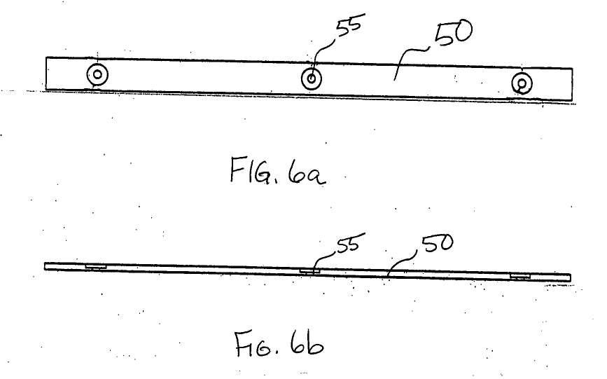

Referring to FIG. 6, back plate 50 as shown in FIGS. 2, 3 and 5 includes holes 55 with a counter sink section to accommodate a screw that will lie flush with the surface of back plate 50.

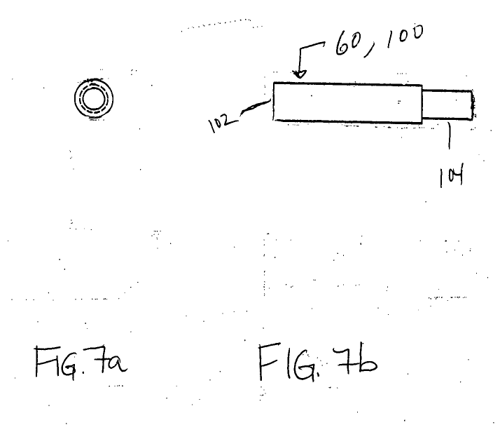

Referring to FIG. 7, extension post 100 as shown in FIG. 2 (or post 60 as shown in the non-welded post embodiment described with respect to FIG. 3), has female thread 102 at one end of extension post 100 and male thread 104 at the opposing end. Additional extension posts can be used to accommodate the needs of the consumer and create a scrapbook as thick as desired.

In the foregoing description, certain terms have been used for brevity, clearness and understanding; but no unnecessary limitations are to be implied therefrom beyond the requirements of the prior art, because such terms are used for descriptive purposes and are intended to be broadly construed. Moreover, the description and illustration of the inventions is by way of example, and the scope of the inventions is not limited to the exact details shown or described.

Although the foregoing detailed description of the present invention has been described by reference to an exemplary embodiment, and the best mode contemplated for carrying out the present invention has been shown and described, it will be understood that certain changes, modification or variations may be made in embodying the above invention, and in the construction thereof, other than those specifically set forth herein, may be achieved by those skilled in the art without departing from the spirit and scope of the invention, and that such changes, modification or variations are to be considered as being within the overall scope of the present invention. Therefore, it is contemplated to cover the present invention and any and all changes, modifications, variations, or equivalents that fall with in the true spirit and scope of the underlying principles disclosed and claimed herein. Consequently, the scope of the present invention is intended to be limited only by the attached claims, all matter contained in the above description and shown in the accompanying drawings shall be interpreted as illustrative and not in a limiting sense.

Having now described the features, discoveries and principles of the invention, the manner in which the invention is constructed and used, the characteristics of the construction, and advantageous, new and useful results obtained; the new and useful structures, devices, elements, arrangements, parts and combinations, are set forth in the appended claims.

It is also to be understood that the following claims are intended to cover all of the generic and specific features of the invention herein described, and all statements of the scope of the invention which, as a matter of language, might be said to fall therebetween.

What is claimed is:

1. A post assembly for binding a book comprising:
a first plate;
a post connected to said first plate at a first end of said post; and
a second plate connected to an opposing end of said post.

2. The post assembly as claimed in claim 1 wherein said first and second plates extend generally along the length of a spine of the book.

3. The post assembly as claimed in claim 1 wherein the post is welded to said first plate.

4. The post assembly as claimed in claim 2 wherein said second plate is screw-connected to said post.

5. The post assembly as claimed in claim 1 wherein at least one of said first and second plates is screw-connected to said post.

6. The post assembly as claimed in claim 5 wherein said at least one of said first and second plates is screw-connected to said post by a screw that extends through a hole in said at least one of said first and second plates.

7. The post assembly as claimed in claim 6 wherein said at least one of said first and second plates includes a counter-sink section of a screw hole for said post.

8. The post assembly as claimed in claim 5 wherein said post includes at least one notched end and said at least one of said first and second plates includes a notched recess for receipt of said notched end of said post.

9. The post assembly as claimed in claim 5 wherein said at least one of said first and second plates includes female threads for receipt of male threads of said post.

10. The post assembly as claimed in claim 1 comprising a plurality posts.

11. The post assembly as claimed in claim 1 wherein at least one of said first and second plates is integrated into a cover portion of the book.

12. The post assembly as claimed in claim 1 wherein the post assembly is separable from the book.

13. The post assembly as claimed in claim 1 wherein said first and second plates are each located on an interior of a cover of said book.
